(19) United States
(12) Patent Application Publication
(10) Pub. No.: US 2018/0222807 A1
(43) Pub. Date: Aug. 9, 2018

(54) INCREASING THE DENSITY OF A BOND COAT

(71) Applicants: Rolls-Royce Corporation, Indianapolis, IN (US); Rolls-Royce High Temperature Composites, Inc., Cypress, CA (US)

(72) Inventors: Sungbo Shim, Irvine, CA (US); Robert Shinavski, Mission Viejo, CA (US); Ann Bolcavage, Indianapolis, IN (US)

(21) Appl. No.: 15/878,970

(22) Filed: Jan. 24, 2018

Related U.S. Application Data
(60) Provisional application No. 62/454,418, filed on Feb. 3, 2017.

(51) Int. Cl. C04B 41/45; C04B 41/00; C04B 41/50; C04B 41/51; C04B 41/52; C04B 41/87; C04B 41/88; C23C 4/134; C23C 4/04; B05D 1/18; B05D 3/02; C23C 4/126

(52) U.S. Cl. CPC C04B 41/456; C23C 4/126; C04B 41/4554; C04B 41/5001; C04B 41/5059; C04B 41/5138; C04B 41/5133; C04B 41/5024; C04B 41/52; C04B 41/87; C04B 41/88; C23C 4/134; C23C 4/04; B05D 1/18; B05D 3/0254; C04B 41/009

(57) ABSTRACT

An example method may include applying a bond coat comprising silicon or a silicon alloy on a surface of a ceramic or ceramic matrix composite substrate, where the bond coat comprises a plurality of pores; infiltrating a precursor into at least some pores of the plurality of pores; and heat-treating the bond coat and the precursor, where after heat-treating a porosity of the bond coat is less than about 5 vol. %, and where after heat-treating, the bond coat is substantially free of continuous porosity extending through a thickness of the bond coat.

This application claims the benefit of U.S. Provisional Application No. 62/454,418 filed Feb. 3, 2017, which is incorporated herein by reference in its entirety.

### TECHNICAL FIELD

The present disclosure generally relates to techniques for increasing the density of a bond coat.

### BACKGROUND

Ceramic or ceramic matrix composite (CMC) substrates may be useful in a variety of contexts where mechanical and thermal properties are important, such as, for example, gas turbine engines. Some ceramic or CMC substrates may react with some elements and compounds present in the operating environment of high temperature mechanical systems, such as, for example, oxygen or water vapor. Reaction with oxygen or water vapor may damage the ceramic or CMC substrate and reduce mechanical properties of the ceramic or CMC substrate, which may reduce the useful lifetime of the component. Thus, a ceramic or CMC substrate may be coated with an environmental barrier coating (EBC) to reduce exposure of the ceramic or CMC substrate to elements and compounds present in the operating environment of high temperature mechanical systems. In some examples, a bond coat may be present between the EBC and the substrate to improve adhesion of the EBC to the substrate.

### SUMMARY

In some examples, the disclosure describes a method that includes applying a bond coat including silicon or a silicon alloy on a surface of a ceramic or ceramic matrix composite substrate, where the bond coat includes a plurality of pores; infiltrating a precursor into at least some pores of the plurality of pores; and heat-treating the bond coat and the precursor, where after heat-treating a porosity of the bond coat is less than about 5 vol. %, and where after heat-treating, the bond coat is substantially free of continuous porosity extending through a thickness of the bond coat.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a conceptual and schematic diagram illustrating an example article that includes a substrate, a bond coat, an overlying layer, and a plurality of pores within the bond coat.

FIG. 2 is a flow diagram illustrating an example technique for increasing the density of a bond coat.

FIG. 3 is a conceptual and schematic cross sectional side view illustrating an example bond coat that is substantially free of continuous porosity.

FIG. 4 is a flow diagram illustrating an example heat-treating step for increasing the density of a bond coat.

FIG. 5 is a flow diagram illustrating an example heat-treating step for increasing the density of a bond coat.

FIG. 6 is a flow diagram illustrating an example heat-treating step for increasing the density of a bond coat.

FIG. 7 is an example flow diagram illustrating an example heat-treating step for increasing the density of a bond coat using a carbonaceous resin.

### DETAILED DESCRIPTION

The disclosure describes example techniques for increasing the density of a bond coat. Such techniques may be used, for example, to increase the density of a bond coat on a ceramic or ceramic matrix composite (CMC) material. The techniques may include infiltrating a precursor into at least some pores of the bond coat and heat-treating the bond coat and precursor to convert the precursor to carbon, a ceramic, a metal, or an alloy, which substantially fills the porosity of the bond coat. For example, porosity of the bond coat after the heat-treatment may be less than about 5 volume percent (vol. %).

In some examples, ceramic or CMC substrates may include silicon metal or a silicon-containing alloy or ceramic, such as silicon carbide or silicon nitride. Materials including silicon metal or a silicon-containing alloy or ceramic may be vulnerable to chemical attack by elements and compounds (e.g., oxygen or water vapor) present in the operating environment of high temperature mechanical systems or during servicing of high temperature mechanical system. For example, oxygen or water vapor may chemically attack a ceramic or CMC substrate that includes silicon to form silicon dioxide or silicon hydroxide species and damage the ceramic or CMC substrate.

To reduce or substantially prevent damage to the ceramic or CMC substrate by chemical attack, the ceramic or CMC substrate may be coated with an environmental barrier coating (EBC), which reduces or substantially prevents elements or compounds from the operating environment from contacting the ceramic or CMC substrate and reacting with the ceramic or CMC substrate. In some examples, a bond coat is between the ceramic or CMC substrate and the EBC and may enhance adherence of the EBC to the ceramic or CMC substrate.

In some examples, the bond coat may be deposited on a ceramic or CMC substrate by a coating process that forms a porous network within the bond coat, such as thermal spraying. The porosity network within the bond coat may allow infiltration of elements or compounds from the operating environment (e.g., oxygen or water vapor) through the bond coat, potentially resulting in contact of the elements or compounds with the substrate. This may result in oxidation of the ceramic or CMC substrate and may lead to premature failure of the ceramic or CMC substrate/EBC system.

The disclosure describes techniques to increase the density of the bond coat to reduce the porosity of the bond coat and thereby reduce the permeability of the bond coat to elements and compounds that may otherwise damage the underlying ceramic or CMC substrate. For example, a technique for increasing the density of a bond coat may include infiltrating a precursor into at least some pores of the bond coat and heat-treating the bond coat and the precursor to convert the precursor to carbon, a ceramic, a metal, or an alloy. After heat-treating, a porosity of the bond coat is reduced. For example, after heat-treating, porosity of the bond coat may be less than about 5 vol. %, and the bond coat may be substantially free of continuous porosity extending through a thickness of the bond coat. By reducing porosity of the bond coat and substantially eliminating continuous porosity extending through a thickness of the bond coat, diffusion of environmental species, such as oxygen or water vapor, through the bond coat to the substrate may be reduced or substantially eliminated, reducing or substantially eliminating chemical attack of the substrate by environmental species.

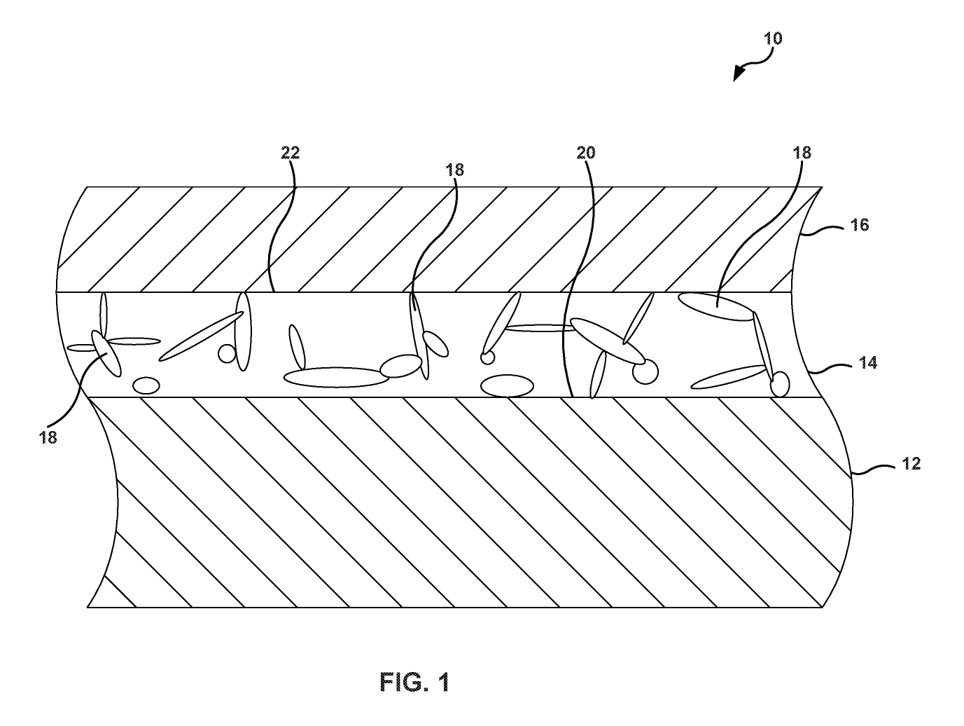

FIG. 1 is a conceptual and schematic diagram illustrating an example article 10 including a substrate 12, a bond coat 14, and an overlying layer 16. Bond coat 14 includes a plurality of pores 18. In some examples, article 10 may include more than three layers.

Substrate 12 may be a component of a high temperature mechanical system. For example, substrate 12 may be a blade track, an airfoil, a blade, a vane, a combustion chamber liner, or the like, of a gas turbine engine. In some examples, substrate 12 includes a ceramic, a ceramic matrix composite (CMC), or a metal alloy that includes silicon metal. In some examples, substrate 12 may include a silicon metal-based material, such as silicon-based ceramic, a silicon-based CMC, or a silicon-based alloy.

In examples in which substrate 12 includes a ceramic, the ceramic may be substantially homogeneous. In some examples, substrate 12 including a ceramic may include a silicon-containing ceramic, such as, for example: silicon oxide (SiO₂), silicon carbide (SiC), or silicon nitride (Si₃N₄); aluminum oxide (Al₂O₃); aluminosilicate (e.g., Al₂SiO₅); or the like. In other examples, substrate 12 may include a metal alloy that includes silicon, such as a molybdenum-silicon alloy (e.g., MoSi₂) or a niobium-silicon alloy (e.g., NbSi₂).

In examples in which substrate 12 includes a CMC, substrate 12 may include a matrix material and a reinforcement material. The matrix material may include a ceramic material, such as, for example, SiC, Si₃N₄, Al₂O₃, aluminosilicate, SiO₂, or the like. The CMC may further include a continuous or discontinuous reinforcement material. For example, the reinforcement material may include discontinuous whiskers, platelets, or particulates. As other examples, the reinforcement material may include a continuous monofilament or multifilament weave. In some examples, the reinforcement material may include SiC, Si₃N₄, Al₂O₃, aluminosilicate, SiO₂, or the like. In some examples, substrate 12 may include a SiC-SiC CMC, in which a fibrous preform including SiC fibers is impregnated with SiC particles from a slurry, then melt infiltrated with silicon metal or a silicon alloy to form the melt-infiltrated SiC≥SiC CMC.

As shown in FIG. 1, substrate 12 defines a surface 20 on which bond coat 14 is disposed. Bond coat 14 defines a surface 22 on which overlying layer 16 is disposed.

Overlying layer 16 may include, for example, an environmental barrier coating (EBC), an abradable layer, a thermal barrier coating (TBC), a calcia-magnesia-aluminosilicate (CMAS)-resistant layer, or the like. In some examples, a single overlying layer 16 may perform two or more of these functions. For example, an EBC may provide environmental protection, thermal protection, CMAS-resistance, and the like to substrate 12. As another example, an abradable layer may provide wear protection, impact protection, and the like to substrate 12. In some examples, instead of including a single overlying layer 16, article 10 may include a plurality of overlying layers, such as at least one EBC layer, at least one abradable layer, at least one TBC layer, at least one CMAS-resistant layer, or combinations thereof

Overlying layer 16 may be formed on surface 22 of bond coat 14 using, for example, thermal spraying, including, air plasma spraying, high velocity oxy-fuel (HVOF) spraying, low vapor plasma spraying; PVD, including EB-PVD, DVD, and cathodic arc deposition; CVD; slurry process deposition; sol-gel process deposition; electrophoretic deposition; or the like.

An EBC layer may include at least one of a rare earth oxide, a rare earth silicate, an aluminosilicate, or an alkaline earth aluminosilicate. For example, an EBC layer may include mullite, barium strontium aluminosilicate (BSAS), barium aluminosilicate (BAS), strontium aluminosilicate (SAS), at least one rare earth oxide, at least one rare earth monosilicate (RE₂SiO₅, where RE is a rare earth element), at least one rare earth disilicate (RE₂Si₂O₇, where RE is a rare earth element), or combinations thereof. The rare earth element in the at least one rare earth oxide, the at least one rare earth monosilicate, or the at least one rare earth disilicate may include at least one of Lu (lutetium), Yb (ytterbium), Tm (thulium), Er (erbium), Ho (holmium), Dy (dysprosium), Tb (terbium), Gd (gadolinium), Eu (europium), Sm (samarium), Pm (promethium), Nd (neodymium), Pr (praseodymium), Ce (cerium), La (lanthanum), Y (yttrium), or Sc (scandium).

In some examples, an EBC layer may include at least one rare earth oxide and alumina, at least one rare earth oxide and silica, or at least one rare earth oxide, silica, and alumina. In some examples, an EBC layer may include an additive in addition to the primary constituents of the EBC layer. For example, an EBC layer may include at least one of TiO₂, Ta₂O₅, HfSiO₄, an alkali metal oxide, or an alkali earth metal oxide. The additive may be added to the EBC layer to modify one or more desired properties of the EBC layer. For example, the additive components may increase or decrease the reaction rate of the EBC layer with CMAS, may modify the viscosity of the reaction product from the reaction of CMAS and the EBC layer, may increase adhesion of the EBC layer to bond coat 14, may increase or decrease the chemical stability of the EBC layer, or the like.

In some examples, the EBC layer may be substantially free (e.g., free or nearly free) of hafnia and/or zirconia. Zirconia and hafnia may be susceptible to chemical attack by CMAS, so an EBC layer substantially free of hafnia and/or zirconia may be more resistant to CMAS attack than an EBC layer that includes zirconia and/or hafnia.

In some examples, an EBC layer may include a base material, a first additive, and a second additive. The base material may include, for example, at least one of a glass ceramic, a rare earth disilicate, a rare earth monosilicate, or a rare earth oxide. In some examples, the base material may include BSAS, SAS, or BAS. In other examples, the base material may include yttrium disilicate (Y₂Si₂O₇), ytterbium disilicate (Yb₂Si₂O₇), yttria, (Y₂O₃), ytterbia (Yb₂O₃), yttrium monosilicate (Y₂Si)₅), or ytterbium monosilicate (Yb₂SiO₅). In some examples, the EBC layer may include between about 50 wt. % and about 99 wt. % of the base material, such as between about 60 wt. % and about 95 wt. % of the base material, or between about 70 wt. % and about 90 wt. % of the base material.

The EBC layer also may include a first additive. The first additive may be selected to facilitate bonding of the EBC layer with bond coat 14, which includes silicon metal. In some examples, the first additive includes silicon metal or an alloy including silicon metal. In other examples, the first additive consists essentially of silicon metal, or consists of silicon metal. In some examples, the EBC layer may include between about 0.5 wt. % and about 20 wt. % of the first additive, such as between about 0.5 wt. % and about 10 wt. % of the first additive, or between about 1 wt. % and about 5 wt. % of the first additive. In some examples, the first additive may react with one or more other constituents of the EBC layer. However, EBC layer may include the stated amount of the first additive at the time of formation of the EBC layer.

The EBC layer also may include a second additive. The second additive may facilitate sintering of the EBC layer and formation of a substantially dense EBC layer. For example, the second additive may react with one or more other constituents of EBC layer to form a phase with a relatively low melting temperature (e.g., a melting temperature lower than at least one other phase in the EBC layer). In this way, the phase with the relatively low melting temperature may sinter or flow more readily and may fill porosity in the EBC layer.

In some examples, the second additive may include at least one of a pre-ceramic polymer, such as polysilazane, a rare earth oxide, alumina, silica, titanium oxide, tantalum oxide, boron oxide, an alkali metal oxide, an alkali earth metal oxide, aluminum, or a rare earth metal. In some examples, the EBC layer may include between about 0.5 wt. % and about 30 wt. % of the second additive, such as between about 0.5 wt. % and about 15 wt. % of the second additive, or between about 1 wt. % and about 5 wt. % of the second additive.

Regardless of the composition of the EBC layer, in some examples, the EBC layer may have a dense microstructure, a porous microstructure, a columnar microstructure, or a combination of at least two of dense, porous, or columnar microstructures. A dense microstructure may be more effective in preventing the infiltration of CMAS and other environmental contaminants, while a porous or columnar microstructure may be more strain tolerant during thermal cycling. A combination of dense, porous, and columnar microstructures may be more effective in preventing the infiltration of CMAS or other environmental contaminants than a porous or fully columnar microstructure while being more strain tolerant during thermal cycling than a fully dense microstructure. In some examples, an EBC layer with a dense microstructure may have a porosity of less than about 10 vol. %, such as less than about 8 vol. %, less than about 5 vol. %, or less than about 2 vol. %, where porosity is measured as a percentage of pore volume divided by total volume of the EBC layer. In some examples, an EBC layer with a porous microstructure may have a porosity of more than about 10 vol. %, such as more than about 15 vol. %, more than 20 vol. %, or more than about 30 vol. %, where porosity is measured as a percentage of pore volume divided by total volume of the EBC layer.

As described above, the EBC layer may be used as a single overlying layer 16 or may be used in combination with at least one other layer, such as an abradable layer or TBC layer.

Overlying layer 16 additionally or alternatively may include an abradable layer. Abradability may include a disposition to break into relatively small pieces when exposed to a sufficient physical force. Abradability may be influenced by the material characteristics of the abradable layer, such as fracture toughness and fracture mechanism (e.g., brittle fracture), as well as the porosity of the abradable layer. Thermal shock resistance and high temperature capability may be important for use in a gas turbine engine, in which the abradable layer is exposed to wide temperature variations from high operating temperatures to low environmental temperatures when the gas turbine engine is not operating. In addition to at least some of the above properties, the abradable layer may possess other properties.

The abradable layer may include any suitable material. For example, the abradable layer may include at least one of a rare earth oxide, a rare earth silicate, an aluminosilicate, or an alkaline earth aluminosilicate. For example, an abradable layer may include mullite, BSAS, BAS, SAS, at least one rare earth oxide, at least one rare earth monosilicate, at least one rare earth disilicate, or combinations thereof. In some examples, the abradable layer may include any of the compositions described herein with respect to the EBC layer.

The abradable layer may be porous. Porosity of the abradable layer may reduce a thermal conductivity of the abradable layer and/or may affect the abradability of the abradable layer. In some examples, the abradable layer includes porosity between about 10 vol. % and about 50 vol. %. In other examples, the abradable layer includes porosity between about 15 vol. % and about 35 vol. %, or about 20 vol. %. Porosity of the abradable layer is defined herein as a volume of pores or cracks in the abradable layer divided by a total volume of the abradable layer (including both the volume of material in the abradable layer and the volume of pores/cracks in the abradable layer).

The abradable layer may be formed using, for example, a thermal spraying technique, such as, for example, plasma spraying. Porosity of the abradable layer may be controlled by the use of coating material additives and/or processing techniques to create the desired porosity. In some examples, substantially closed pores may be desired.

For example, a coating material additive that melts or burns at the use temperatures of the component (e.g., a blade track) may be incorporated into the coating material that forms the abradable layer. The coating material additive may include, for example, graphite, hexagonal boron nitride, or a polymer such as a polyester, and may be incorporated into the coating material prior to deposition of the coating material over substrate 12 to form the abradable layer. The coating material additive then may be melted or burned off in a post-formation heat treatment, or during operation of the gas turbine engine, to form pores in the abradable layer. The post-deposition heat-treatment may be performed at up to about 1500° C.

The porosity of the abradable layer can also be created and/or controlled by plasma spraying the coating material using a co-spray process technique in which the coating material and coating material additive are fed into the plasma stream with two radial powder feed injection ports. The feed pressures and flow rates of the coating material and coating material additive may be adjusted to inject the material on the outer edge of the plasma plume using direct 90 degree angle injection. This may permit the coating material particles to soften but not completely melt and the coating material additive to not burn off but rather soften sufficiently for adherence in the abradable layer.

As described above, the abradable layer may be used as a single overlying layer 16 or may be used in combination with at least one other layer, such as an EBC layer or TBC layer.

Overlying layer 16 additionally or alternatively may include a TBC layer. The TBC may have a low thermal conductivity (i.e., both an intrinsic thermal conductivity of the material(s) that forms the TBC and an effective thermal conductivity of the TBC as constructed) to provide thermal insulation to substrate 12, bond coat 14, and/or overlying layer 16. Heat is transferred through the TBC through conduction and radiation. The inclusion of rare earth oxides such as ytterbia, samaria, lutetia, scandia, ceria, gadolinia, neodymia, europia, yttria-stabilized zirconia (YSZ), zirconia stabilized by a single or multiple rare earth oxides, hafnia stabilized by a single or multiple rare earth oxides, zirconia-rare earth oxide compounds, such as RE₂Zr₂O₇ (where RE is a rare earth element), hafnia-rare earth oxide compounds, such as RE₂Hf₂O₇ (where RE is a rare earth element), and the like as dopants may help decrease the thermal conductivity (by conduction) of the TBC.

As described above, the TBC layer may be used as a single overlying layer 16 or may be used in combination with at least one other layer, such as an EBC layer or an abradable layer.

Article 10 also includes bond coat 14. In some examples, bond coat 14 may be disposed directly on surface 20 with no intermediate layers between substrate 12 and bond coat 14. In other examples, bond coat 14 may not be disposed directly on surface 20, i.e., one or more additional intermediate layers may be disposed between substrate 12 and bond coat 14. For example, an additional intermediate bond coat layer may be disposed between substrate 12 and bond coat 14. In some examples, bond coat 14 may be on all of surface 20 of substrate 12. In other examples, bond coat 14 may be on only a part of surface 20 of substrate 12. For example, bond coat 14 may be on a portion of substrate 12 that is exposed to a flow path of hot gases in a gas turbine engine. In other examples, bond coat 14 may be on non-gas flow path areas, such as a backside of a seal segment or a blade dovetail region.

Bond coat 14 may include a composition that provides adherence between substrate 12 and a layer formed on bond coat 14, such as overlying layer 16. In some examples, the adherence provided by bond coat 14 between substrate 12 and overlying layer 16 may be greater than the adherence between substrate 12 and overlying layer 16, without bond coat 14.

Bond coat 14 may include a composition that may be stable at temperatures above 1350° C. and/or above about 1410° C. In this way, bond coat 14 may allow use of article 10 at temperatures which lead to temperatures of bond coat 14 above 1350° C. and/or above about 1410° C. In some examples, article 10 may be used in an environment in which ambient temperature is greater than the temperature at which bond coat 14 is thermally stable, e.g., because bond coat 14 may be coated with at least one layer, such as overlying layer 16, that provides thermal insulation to bond coat 14 and reduces the temperature experienced by bond coat 14 compared to the ambient temperature or the surface temperature of the layer(s) formed on bond coat 14, e.g., overlying layer 16.

Bond coat 14 may include silicon metal (e.g., elemental silicon), a silicon-containing alloy, a silicon-containing ceramic, or a silicon-containing compound. In some examples, the presence of Si in bond coat 14 may promote adherence between bond coat 14 and substrate 12, such as, for example, when substrate 12 includes silicon metal or a silicon-containing alloy or compound.

Bond coat 14 may optionally include at least one additive. The optional at least one additive may include, for example, at least one of SiC, a melting point depressant, an oxidation enhancer, a transition metal carbide, a transition metal boride, or a transition metal nitride. SiC may affect the properties of bond coat 14. For example, SiC particles may modify oxidation resistance of bond coat 14, modify chemical resistance of bond coat 14, influence the coefficient of thermal expansion (CTE) of bond coat 14, or the like. In some examples, bond coat 14 may include between about 1 vol. % and about 40 vol. % SiC, such as between about 1 vol. % and about 20 vol. % SiC, or between about 5 vol. % and about 40 vol. % SiC, or between about 5 vol. % and about 20 vol. % SiC.

In examples in which bond coat 14 includes a melting point depressant, the melting point depressant may include a metal or alloy, such as at least one of zirconium metal, yttrium metal, titanium metal, aluminum metal, chromium metal, niobium metal, tantalum metal, or a rare earth metal. Rare earth metals may include scandium, yttrium, lanthanum, cerium, praseodymium, neodymium, promethium, samarium, europium, gadolinium, terbium, dysprosium, holmium, erbium, thulium, ytterbium, and lutetium. In some examples in which bond coat 14 includes a melting point depressant, bond coat 14 may include greater than 0 wt. % and less than about 30 wt. % of the melting point depressant, such as greater than 0 wt. % and less than about 10 wt. % of the melting point depressant. In some examples, bond coat 14 may include at least two melting point depressants, and bond coat 14 may include greater than 0 wt. % and less than about 30 wt. % of each of the at least two melting point depressants, 0 wt. % and less than about 10 wt. % of each of the at least two melting point depressants. The melting point depressant may reduce a melting point of a bond coat precursor of bond coat 14 that is formed as part of the technique for forming bond coat 14. This may allow melting of the bond coat precursor at lower temperatures, which may reduce a chance that the melting of the bond coat precursor to form bond coat 14 damages substrate 12.

In examples in which bond coat 14 includes an oxidation enhancer, the oxidation enhancer may include at least one of molybdenum, hafnium, or ytterbium. In some examples in which bond coat 14 includes an oxidation enhancer, bond coat 14 may include greater than 0 wt. % and less than about 10 wt. % of the oxidation enhancer. In some examples, bond coat 14 may include at least two oxidation enhancers, and bond coat 14 may include greater than 0 wt. % and less than about 10 wt. % of each of the at least two oxidation enhancers. The oxidation enhancer may facilitate formation of a stable oxide scale on a surface of bond coat 14, which may increase adhesion between bond coat 14 and overlying layer 16, reduce diffusion of elements through bond coat 14, or both.

Bond coat 14 additionally or alternatively may include at least one of a transition metal carbide, a transition metal boride, or a transition metal nitride. Bond coat 14 may include silicon and at least one transition metal carbide; silicon and at least one transition metal boride; silicon and at least one transition metal nitride; silicon, at least one transition metal carbide, and at least one transition metal boride; silicon, at least one transition metal carbide, and at least one transition metal nitride; silicon, at least one transition metal boride, and at least one transition metal nitride; or silicon, at least one transition metal carbide, at least one transition metal boride, and at least one transition metal nitride. The transition metal may include, for example, Cr, Mo, Nb, W, Ti, Ta, Hf, or Zr. The at least one transition metal carbide may include at least one of Cr₃C₂, Cr₇C₃, Cr₂₃C₆, Mo₂C, NbC, WC, TaC, HfC, or ZrC. The at least one transition metal boride may include at least one of TaB, TaB₂, TiB₂, ZrB₂, HfB, or HfB₂. The at least one transition metal nitride may include at least one of TiN, ZrN, HfN, Mo₂N, or TaN.

In some examples, bond coat 14 may include between about 40 volume percent (vol. %) and about 99 vol. % silicon and a balance of the at least one of a transition metal carbide or a transition metal boride. For example, bond coat 14 may include between 1 vol. % and about 60 vol. % of the at least one of a transition metal carbide, a transition metal boride, or a transition metal nitride, and a balance silicon an any additional constituents (such as silicon carbide). In some examples, bond coat 14 may include between about 1 vol. % and about 30 vol. %, or between about 5 vol. % and about 20 vol. % of the at least one of a transition metal carbide, a transition metal boride, or a transition metal nitride, and a balance silicon metal and any additional constituents (such as silicon carbide). The particular composition ranges may vary based on the CTE of the at least one of a transition metal carbide, a transition metal boride, or a transition metal nitride.

Transition metal carbides, transition metal borides, and transition metal nitrides may have a different CTE than silicon. For example, transition metal carbides and transition metal borides may have CTEs between about 5 ppm/° C. and about 8 ppm/° C., and and transition metal nitrides may have CTEs of about 9 ppm/° C. By mixing silicon and a transition metal carbide, a transition metal boride, or both, the CTE of bond coat 14 may be increased to more closely match the CTE of substrate 12, the CTE of overlying layer 16, or both. This may reduce stress at the interfaces between substrate 12 and bond coat 14, between bond coat 14 and overlying layer 16, or both, during thermal cycling of article 10.

Additionally, or alternatively, the addition of the at least one of the transition metal carbide, the transition metal boride, or the transition metal nitride may improve oxidation resistant of bond coat 14 compared to a bond layer including only silicon. For example, the at least one of the transition metal carbide, the transition metal boride, or the transition metal nitride may be incorporated into the thermally grown silicon oxide, which may improve adherence of the thermally grown silicon oxide to the bond layer, decrease oxygen diffusivity through the thermally grown silicon oxide (which reduces the rate of oxidation of the remaining bond layer), or both.

Bond coat 14 may define any suitable thickness, measured in a direction substantially normal to surface 20 of substrate 12. In some examples, bond coat 14 defines a thickness of between about 0.5 mils (about 12.7 micrometers) and about 40 mils (about 1016 micrometers), such as between about 1 mils (about 25.4 micrometers) and about 10 mils (about 254 micrometers).

Bond coat 14 may be formed on substrate 12 using, for example, thermal spraying, e.g., air plasma spraying, high velocity oxy-fuel (HVOF) spraying, low vapor plasma spraying; physical vapor deposition (PVD), e.g., electron beam physical vapor deposition (EB-PVD), directed vapor deposition (DVD), cathodic arc deposition; chemical vapor deposition (CVD); slurry process deposition; sol-gel process deposition; electrophoretic deposition; or the like.

The process used to form bond coat 14 may result in bond coat 14 including a plurality of pores 18. The plurality of pores 18 may allow infiltration of elements or compounds (e.g., oxygen or water vapor) through bond coat 14, potentially resulting in contact of the elements or compounds with at least a portion of substrate 12. Contact of the elements or compounds (e.g., oxygen or water vapor) with at least a portion of substrate 12 may result in oxidation of at least a portion of substrate 12. Oxidation of at least a portion of substrate 12 may lead to premature failure of at least a portion of article 10 or otherwise damage substrate 12. For example, during operation of article 10, water vapor and/or oxygen in the operating environment of article 10 may infiltrate through overlying layer 16 into bond coat 14, and through pores 18. The infiltrated water vapor and/or oxygen may contact substrate 12 which may result in oxidation, as described above.

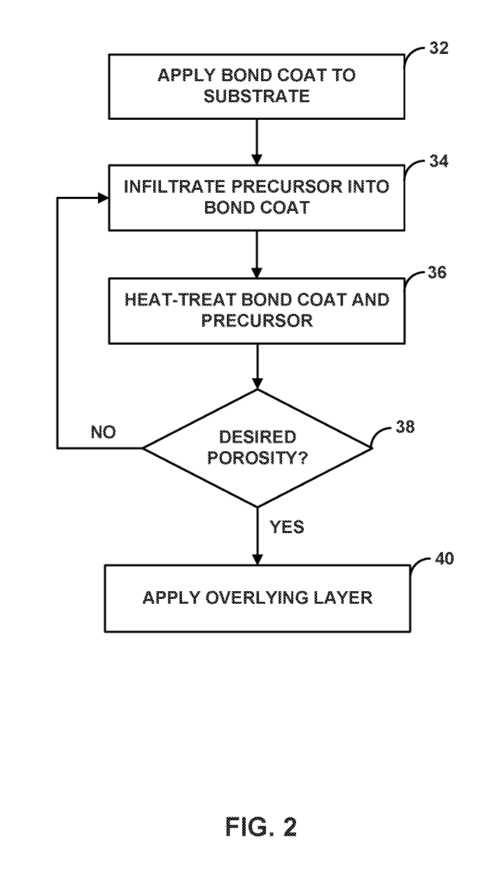

In some examples, increasing the density of bond coat 14 may reduce the porosity of bond coat 14 and thereby reduce the permeability of bond coat 14 to elements and compounds (e.g., oxygen or water vapor) present in the operating environment of article 10 that may oxidize substrate 12 or otherwise damage article 10. FIG. 2 is a flow diagram illustrating an example technique for increasing the density of bond coat 14 by at least partially filling at least some pores of plurality of pores 18.

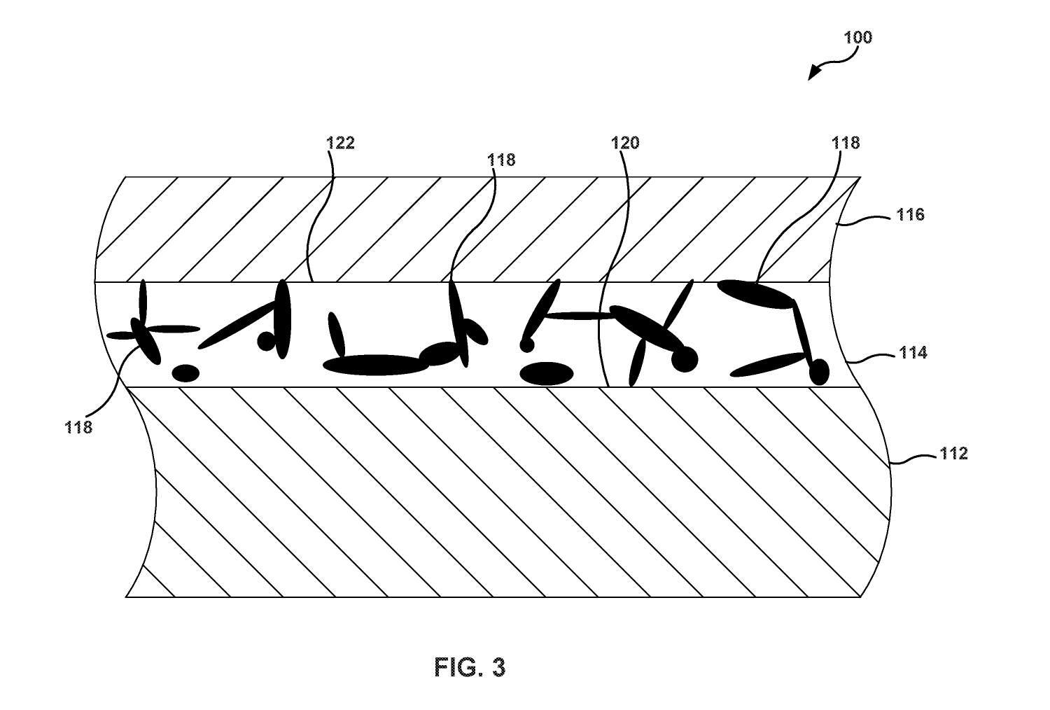

The technique of FIG. 2 will be described with respect to article 10 of FIG. 1 and article 100 of FIG. 3 for ease of description only. A person having ordinary skill in the art will recognize and appreciate that the technique of FIG. 2 may be used to form articles other than article 10 of FIG. 1.

The technique of FIG. 2 may include applying bond coat 14 to surface 20 of substrate 12 (32) using any technique that leaves residual porosity in bond coat 14. For example, bond coat 14 may be applied to surface 20 using a technique such as air plasma spraying, high velocity oxy-fuel (HVOF) spraying, low vapor plasma spraying, physical vapor deposition (PVD), electron beam physical vapor deposition (EB-PVD), directed vapor deposition (DVD), chemical vapor deposition (CVD), cathodic arc deposition, slurry process deposition, sol-gel process deposition, electrophoretic deposition, or the like (32). Applying bond coat 14 to surface 20 of substrate 12 may result in formation of a plurality of pores 18 within bond coat 14. In some examples, plurality of pores 18 may include continuous porosity networks and discontinuous pores. In some examples, at least a portion of plurality of pores 18 may form porosity networks that extend substantially from surface 20 to surface 22 (e.g., continuous pores that may allow ingress of oxygen or water vapor into substrate 12). In some examples, after applying bond coat 14 to substrate 12, bond coat 14 may include between about 1 vol. % and about 15 vol. % of pores 18, or between about 3 vol. % and about 8 vol. % of pores 18.

The technique of FIG. 2 may include, after applying bond coat 14, infiltrating a precursor into at least some of the plurality of pores 18 within bond coat 14 (34). Infiltrating the precursor may utilize any suitable infiltration process. For example, infiltrating the precursor may include dipping bond coat 14 into the precursor or a mixture including the precursor to infiltrate the precursor into at least some pores of the plurality of pores 18. As another example, infiltrating the precursor may include vacuum infiltrating the precursor or a mixture including the precursor into at least some pores of the plurality of pores 18. As other examples, infiltrating the precursor may include spraying, painting, or the like.

The precursor may be infiltrated into at least some pores of the plurality of pores 18. For example, the precursor may be infiltrated into substantially all pores of the plurality of pores 18 that are open to surface 22 or are connected to surface 22 by a porous network. In other words, in some examples, he precursor may be infiltrated into substantially all open pores within bond coat 14.

The precursor may include at least one element or compound that may infiltrate at least some of the plurality of pores 18. Infiltration into at least some of the plurality of pores 18 of a precursor configured to undergo subsequent heat treatment may allow at least some of the plurality of pores 18 to be substantially filled and thereby reduce the porosity of bond coat 14. In some examples, the precursor may include any suitable precursor material that is converted to a metal, an alloy, a ceramic, or a carbon within pores 18, and, optionally, a solvent, a dispersant, a viscosity adjusting agent, a surface tension adjusting agents, or the like. In some examples, the precursor may include at least one of a pre-ceramic polymer solution, a metallic precursor solution, a metal alkoxide solution, or a carbonaceous resin.

In some examples, a precursor including a pre-ceramic polymer solution may include a solvent and a pre-ceramic polymer. The solvent may include a polar solvent, for example, an alcohol such as isopropanol, a ketone such as acetone, water, hexane, tetrahydrofuran, toluene, or the like. The solvent may be selected, for example, such that the pre-ceramic polymer is soluble or miscible in the solvent or such that the pre-ceramic polymer solution has a desired viscosity.

The pre-ceramic polymer may include, for example, polycarbosilanes (e.g., polycarbomethylsilane, allyl hydrido polycarbosilane, SMP-10 available from Starfire Systems, Glenville, N.Y., and the like); polysilazanes; and the like. The pre-ceramic polymer may be selected, for example, such that heat treatment of the pre-ceramic polymer solution results in a desired ceramic material. In some examples, the pre-ceramic polymer may have a number average molecular weight selected to control, for example, a viscosity of the pre-ceramic polymer solution to provide improved infiltration of the pre-ceramic polymer into at least some of the plurality of pores 18, or the like.

In some examples, the concentration of the pre-ceramic polymer in the pre-ceramic polymer solution may be in the range of about 50 weight percent (wt %) to about 100 wt %. For example, where the pre-ceramic polymer includes 90 wt % SMP-10 and 10 wt % toluene, the concentration of SMP-10 and toluene in the pre-ceramic polymer solution may be in the range of about 50 wt % to about 100 wt %. The weight percent of pre-ceramic polymer in solution may be selected, for example, to control a viscosity of the pre-ceramic polymer solution to improve infiltration of the pre-ceramic polymer solution into at least some of the plurality of pores 18, or the like.

In some examples, the pre-ceramic polymer solution may include an at least one additional constituent. For example, the at least one additional constituent may include metal oxide fillers, such as, for example, alumina, magnesia, zirconia, or the like). The metal oxide filler may be selected, for example, such that during heat-treatment a desired ceramic phase is formed by reaction between the ceramic from pre-ceramic polymer and the metal oxide filler. As another example, the at least one additional constituent may include SiC, SiN, or the like. The additional constituents may, for example, reduce cracking during pyrolysis, promote crystal growth during pyrolysis, or the like.

In some examples, the precursor may include a metallic precursor solution. A metallic precursor solution may include a polar solvent and a metallic precursor. The polar solvent may include, for example, water, an alcohol, and the like. The solvent may be selected, for example, such that the metallic precursor is soluble in the solvent. The metallic precursor may include, for example, an ammonium metal oxide, such as (NH₄)₂Mo₂O₇, (NH₄)₆Mo₇O₂₄·4H₂O, (NH₄)₂MoO, (NH₄)₂(H₂W₁₂O₄₂)·₄H₂O, or the like. The metallic precursor may be selected based on, for example, the ease of reduction of the metallic precursor to a pure metal, the pure metal reduction product, or the like.

In some examples, the concentration of the metallic precursor in the metallic precursor solution may be in the range of about 30 mole percent (mol %) to about 80 mol %. For example, where the metallic precursor includes (NH₄)₂Mo₂O₇ and water the concentration of (NH₄)₂Mo₂₀₇ in the metallic precursor solution may be in the range of about 50 mol % to about 70 mol %. The weight percent of the metallic precursor in the metallic precursor solution may be selected, for example, to control a viscosity of the metallic precursor solution to improve infiltration of the metallic precursor solution into at least some of the plurality of pores 18, or the like.

In some examples, the precursor may include a metal alkoxide solution. A metal alkoxide solution may include a solvent and a metal alkoxide precursor. The solvent may include may include a single solvent or a solvent mixture, for example, an alcohol (e.g., ethanol, isopropanol, isobutanol, or the like), an acid (e.g., nitric acid, or the like), and water; or the like. The solvent may be selected, for example, such that the metal alkoxide is soluble or miscible in the solvent. The metal alkoxide may include, for example, an aluminum alkoxide (e.g., aluminum isopropoxide, or the like), a zirconium alkoxide (e.g., zirconium ethoxide, or the like), or the like. The metal alkoxide may be selected, for example, such that heat treatment of the metal alkoxide solution results in a desired ceramic, metal, or alloy phase.

In some examples, the precursor may include a carbonaceous resin. A carbonaceous resin may include, for example, furfural, furfuryl alcohol, phenolic resins, or the like. In some examples, the carbonaceous resin may optionally include a solvent. The optional solvent may include an organic solvent, such as, for example, acetone, ethanol, or the like. The solvent may be selected, for example, such that the carbonaceous resin has a desired viscosity to improve infiltration of the carbonaceous resin into at least some of the plurality of pores 18, or the like.

In some examples, the carbonaceous resin may include at least one additional constituent. For example, the at least one additional carbonaceous resin constituent may include SiC, SiN, or the like. The additional constituents may, for example, reduce cracking during pyrolysis, or the like.

The technique of FIG. 2 may include, after infiltrating the precursor, heat-treating bond coat 14 and the precursor (36). In some examples, heat-treating bond coat 14 and the precursor may include heat-treating bond coat 14 and the precursor at a temperature between about 450° C. to about 1200° C. Heat-treating may include heating bond coat 14 and the precursor by any suitable means. For example, heating may include heating by conduction, convection, or radiation using a furnace, a laser, a plasma, an arc welding apparatus, or the like.

In some examples, heat-treating bond coat 14 and the precursor may include pyrolyzing a carbonaceous resin precursor to carbon, converting a pre-ceramic polymer precursor to a ceramic, converting a metal alkoxide or metallic precursor to a metal or metal alloy, or the like. In some examples, heat-treating bond coat 14 and the precursor may include a single heat-treatment step or may include a plurality of steps, such as, for example, drying bond coat 14 and the precursor, cleaning bond coat 14 with or without the infiltrated precursor, curing the precursor, pyrolyzing the precursor, reducing the precursor by a reduction reaction, and the like.

After heat-treating bond coat 14 and the precursor, the plurality of pores 18 may be at least partially filled with carbon, a ceramic, a metal, or an alloy. In some examples, during heat-treating bond coat 14 and the precursor, the precursor may react with one or more constituents of substrate 12 or bond coat 14 to form a reaction product (e.g., silicon in the bond coat may react with carbon in the precursor to form silicon carbide). In some examples, heat-treating bond coat 14 and the precursor (36) may include one or more additional steps.

The technique of FIG. 2 also may include, after heat-treating bond coat 14 and the precursor, determining if bond coat 14 has a desired porosity (38). If the porosity is determined to be sufficient (YES branch of decision block 38), the technique may not include further infiltrating the precursor or heat-treating bond coat 14 and the precursor. Porosity of bond coat 14 may be determined by, for example, measuring a change in weight of the substrate 12 and bond coat 14 before and after pyrolysis, and using a known density of the precursor to estimate a volume occupied by the precursor. As another example, porosity of bond coat 14 may be determined by image analysis of a cross section of bond coat 14 after pyrolysis. In some examples, if porosity of bond coat 14 is less than about 10 vol. %, less than about 5 vol. %, or less than about 1 vol. %, where porosity is measured as a percentage of pore volume divided by total volume of bond coat 14, and/or bond coat 14 is substantially free of continuous porosity extending through the thickness of bond coat 14, then the porosity of bond coat 14 may be considered sufficient.

If the porosity is determined to be too high (NO branch of decision block 38), then the technique may include repeating the steps of infiltrating the precursor (34) and heat-treating bond coat 14 and the precursor (36). For example, if porosity of bond coat 14 is greater than about 10 vol. %, greater than about 5 vol. %, or greater than about 1 vol. %, and/or if bond coat 14 is not substantially free of continuous porosity extending through the thickness of bond coat 14, then the porosity of bond coat 14 may be considered too high, and infiltration (34) and heat-treating (36) may be repeated.

In some examples, the determination of the sufficiency of the porosity may be determined at an intermediate heat-treating step. For example, where the precursor is a per-ceramic polymer, the determination of the adequacy of the porosity may be made after pyrolyzing the pre-ceramic polymer (56) or after cleaning surface 22 of bond coat 14 (58).

FIG. 3 is a conceptual and schematic cross sectional side view illustrating an example article 100, including a substrate 112, a bond coat 114, an overlying layer 116, after treatment of bond coat 114 in accordance with one or more of the techniques described above. For example, article 100 may include substantially the same substrate, bond coat, and overlying layer as describe with respect to FIG. 1, except that the plurality of pores 118 of bond coat may be substantially filled with carbon, a ceramic, a metal, or an alloy such that bond coat 114 may be substantially free of continuous porosity extending through the thickness of bond coat 114. For example, a porosity of bond coat 114 may be less than about 10 vol. %, less than about 5 vol. %, or less than about 1 vol. %, where porosity is measured as a percentage of pore volume divided by total volume of bond coat 114, and/or bond coat 114 may be substantially free of continuous porosity extending from surface 120 to surface 122.

In examples where the plurality of pores 118 are substantially filled with carbon, a ceramic, a metal, or an alloy, the infiltration of elements or compounds present in the operating environment of article 100 (e.g., oxygen or water vapor) through bond coat 114 may be reduced or substantially slowed. Reducing or substantially slowing the infiltration of elements or compounds through bond coat 114 may reduce or slow contact of the elements or compounds with substrate 112. Reducing or substantially slowing the contact of the elements or compounds with substrate 112 may reduce or substantially slow oxidation of substrate 12. Reducing or substantially slowing oxidation of substrate 112 may reduce or substantially slow damage to substrate 112 or the substrate 112/overlying layer 116 system.

The technique of FIG. 2 also may include, after determining that the porosity of bond coat 14 is sufficient (YES branch of decision block 38), applying overlying layer 16 on bond coat 14 (40). As described above, overlying layer 16 may include, for example, at least one of an EBC, an abradable layer, a TBC, a CMAS-resistant layer, or the like. For example, the technique of FIG. 2 may include, after determining that the porosity of bond coat 14 is sufficient (YES branch of decision block 38), applying an EBC on bond coat 14 and applying an abradable layer on the EBC.

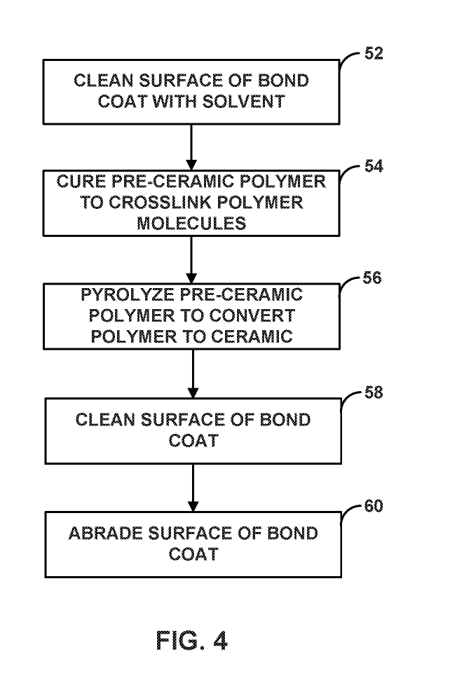

As described above, the precursor may include one or more components, including, for example, a pre-ceramic polymer, a metallic precursor, a metal alkoxide, or a carbonaceous resin. Converting each of these precursors to a ceramic, metal, alloy, or carbon may utilize a respective technique. For example, FIG. 4 is an example flow diagram illustrating example details of heat-treating step (36) of the technique of FIG. 2 in examples in which the precursor includes a pre-ceramic polymer. In examples in which the precursor includes a pre-ceramic polymer, heat-treating bond coat 14 and the precursor (36) may include, after infiltrating the pre-ceramic polymer, cleaning surface 22 of bond coat 14 with a solvent or mechanical means (e.g., scrubbing, scraping, grit or water jet blasting, or the like) to remove residual precursor or other material from surface 22 (52). After cleaning surface 22 (52), the technique may include curing the pre-ceramic polymer to crosslink the pre-ceramic polymer (54). For example, bond coat 14 and the pre-ceramic polymer may be heated at a temperature between about 200° C. and about 400° C. to crosslink the pre-ceramic polymer (54). After curing the pre-ceramic polymer (54), the technique of FIG. 4 may include pyrolyzing the pre-ceramic polymer to convert the pre-ceramic polymer to a ceramic (56). For example, bond coat 14 and the cured pre-ceramic polymer may be heated at about 1° C. to about 3° C. per minute to between about 850° C. to about 1300° C., and held at this temperature for about 1 hour to about 2 hours in inert atmosphere to convert the pre-ceramic polymer to a ceramic (56). After pyrolyzing the pre-ceramic polymer (56), the technique may optionally include cleaning surface 22 of bond coat 14 with a solvent or an abrasive (e.g., grit blasting) to remove residual precursor or other material from surface 22 (58). Further, after cleaning surface 22 (58) and before application of overlying layer 16 (40; FIG. 2), the technique of FIG. 4 may include abrading surface 22 to increase roughness of surface 22 and improve adhesion of overlying layer 16 to surface 22 (60).

The steps for heat-treating the pre-ceramic polymer, as described above, may be performed in the order describe above or a different order. In some examples, heat-treating bond coat 14 and the pre-ceramic polymer may include fewer steps or other additional steps. In some examples, one or more steps as described above, including other additional steps, may be repeated.

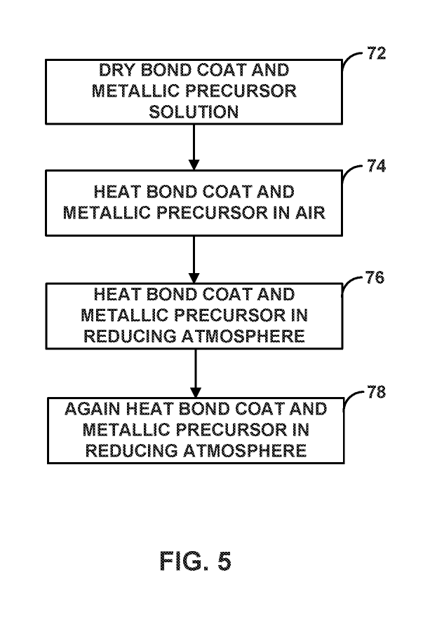

FIG. 5 is an example flow diagram illustrating an example heat-treating step (36) in which the precursor includes a metallic precursor solution. In examples in which the precursor includes a metallic precursor solution, heat-treating bond coat 14 and the precursor (36) may include, for example, after infiltrating the metallic precursor solution, drying bond coat 14 and the metallic precursor (72) to remove residual solvent from bond coat 14 and the metallic precursor. Drying bond coat 14 and the metallic precursor (72) may be accomplished, for example, by heating bond coat 14 and the metallic precursor to a temperature below a boiling point of the solvent in the metallic precursor, applying a partial vacuum or low pressure to bond coat 14 and the metallic precursor, or the like.

After drying the bond coat 14 and metallic precursor (72), the technique of FIG. 5 may include heat-treating bond coat 14 and the metallic precursor to reduce the metallic precursor via a first reduction reaction (74). For example, where the precursor includes a (NH₄)₂Mo₂O₇ solution, heat-treating bond coat 14 and the precursor to reduce the (NH₄)₂Mo₂O₇ may include heat-treating bond coat 14 and the (NH₄)₂Mo₂O₇ at a suitable temperature in air to reduce the (NH₄)₂Mo₂O₇ to MoO₃. After the first reduction reaction (74), bond coat 14 and the metallic precursor may be further heat treated in a reducing atmosphere (e.g., nitrogen, argon, helium, carbon dioxide, combinations thereof, or the like) to further reduce the metallic precursor via a second reduction reaction (76). For example, the second heat treatment may be at a temperature between about 450° C. and about 1200° C. As one example, MoO₃ may be heat-treated at about 450° C. to about 750° C. in a reducing atmosphere to further reduce the MoO₃ to MoO₂.

After the second reduction reaction (76), the technique of FIG. 5 may further include heat-treating bond coat 14 and the metallic precursor at a temperature between about 450° C. and about 1200° C. in a reducing atmosphere to further reduce the metallic precursor to a pure metal via a third reduction reaction (78). For example, MoO₂ may be heated at a temperature between about 900° C. and about 1200° C. in a reducing atmosphere to further reduce the MoO₂ to a pure Mo metal.

The steps for heat-treating the metallic precursor, as described above, may be performed in the order as describe above or a different order. In some examples, heat-treating bond coat 14 and the metallic precursor may include fewer steps or additional steps. In some examples, one or more steps as described above, including other additional steps, may be repeated.

As another example, where the precursor includes a metallic precursor solution, heat-treating bond coat 14 and the precursor may include heat-treating bond coat 14 and the precursor at about 450° C. to about 1200° C. in a reducing atmosphere to reduce the (NH₄)₂Mo₂O₇, (NH₄)₆Mo₇O_{24·4}H₂O, (NH₄)₂MoO₄, or (NH₄)₁₀(H₂W₁₂O₄₂)·₄H₂O to Mo metal or W metal, respectively.

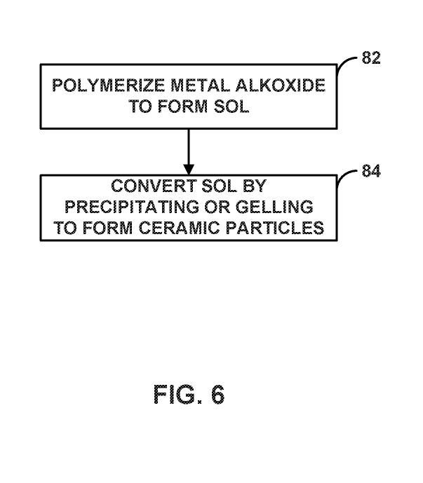

FIG. 6 is an example flow diagram illustrating an example heat-treating step (36) in which the precursor includes a metal alkoxide solution. In some examples in which the precursor includes a metal alkoxide solution, heat-treating bond coat 14 and the precursor (36) may include, after infiltrating the metal alkoxide solution into at least some pores 18 of bond coat 14 (34), polymerizing the infiltrated metal alkoxide solution to form a sol in the at least some pores of the plurality of pores (82). Polymerizing the infiltrated metal alkoxide solution to form a sol may include, for example, partial or complete hydrolysis of the metal alkoxide in the plurality of pores 18 (e.g., via the Stober reaction, or like reactions). After polymerizing the infiltrated metal alkoxide solution, the technique may include converting the sol to a plurality of ceramic particles by at least partially precipitating the sol or gelling the sol (84). Precipitating or gelling the sol may include, for example, allowing the colloid to settle within the plurality of pores 18, drying bond coat 14 and the sol under ambient conditions to remove at least a portion of the solvent, and/or heat-treating bond coat 14 and the sol at a suitable temperature in a suitable atmosphere to remove at least a portion of the solvent. After precipitating or gelling the sol, the technique of FIG. 6 also may include heat treating the bond coat 14 and precipitated sol-gel at a suitable temperature in a suitable atmosphere to remove substantially all of the solvent to remove any residual solvent.

The steps for heat-treating the metal alkoxide solution, as described above, may be performed in the order as describe above or a different order. In some examples, heat-treating bond coat 14 and the metal alkoxide solution may include fewer steps or additional steps. In some examples, one or more steps as described above, including other additional steps, may be repeated.

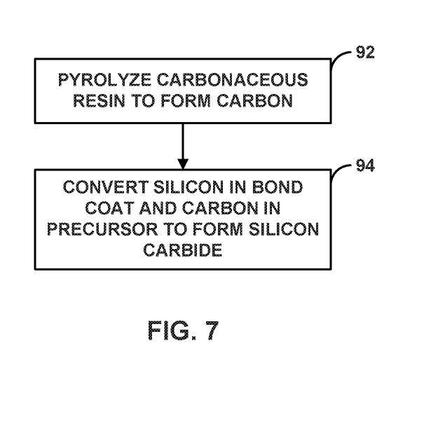

FIG. 7 is an example flow diagram illustrating an example heat-treating step (36) in which the precursor includes a carbonaceous resin. In examples in which the precursor includes a carbonaceous resin, heat-treating bond coat 14 and the precursor (36) may include heating bond coat 14 and the carbonaceous resin at between about 800° C. and about 1000° C. in an inert atmosphere to pyrolyze the carbonaceous resin to form carbon (92). During this heat treatment or a subsequent heat treatment, silicon in bond coat 14 may partially melt and react with carbon in the precursor to form silicon carbide (94). In some examples, where silicon in bond coat 14 and carbon in the precursor are converted to form silicon carbide, after heat-treating substantially all the plurality of pores of bond coat 14 may be substantially filled with silicon carbide.

The steps for heat-treating the carbonaceous resin, as described above, may be performed in the order as describe above or a different order. In some examples, heat-treating bond coat 14 and the carbonaceous resin may include fewer steps or additional steps. In some examples, one or more steps as described above, including other additional steps, may be repeated.

Various examples have been described. These and other examples are within the scope of the following claims.

What is claimed is:

1. A method comprising:
applying a bond coat comprising silicon or a silicon alloy on a surface of a ceramic or ceramic matrix composite substrate, wherein the bond coat comprises a plurality of pores;
infiltrating a precursor into at least some pores of the plurality of pores; and
heat-treating the bond coat and the precursor, wherein after heat-treating a porosity of the bond coat is less than about 5 vol. %, and wherein after heat-treating, the bond coat is substantially free of continuous porosity extending through a thickness of the bond coat.

2. The method of claim 1, wherein the precursor comprises at least one of a pre-ceramic polymer, a metallic precursor, a metal alkoxide, or a carbonaceous resin.

3. The method of claim 1, wherein applying the bond coat comprises air plasma spraying, high velocity oxy-fuel (HVOF) spraying, or low vapor plasma spraying.

4. The method of claim 1, wherein infiltrating the precursor comprises dipping the bond coat into the precursor or a mixture including the precursor into at least some pores of the plurality of pores or vacuum infiltrating the precursor or a mixture including the precursor into at least some pores of the plurality of pores.

5. The method of claim 1, wherein heat-treating the bond coat and the precursor comprises heat-treating the bond coat and the precursor at between about 450° C. to about 1400° C., wherein heat-treating pyrolyzes the precursor to carbon, converts the precursor to a ceramic, or converts the precursor to a pure metal.

6. The method of claim 1, further comprising repeating the steps of infiltrating the precursor and heat-treating the bond coat and the precursor.

7. The method of claim 1, further comprising applying an environmental barrier coating (EBC) layer on the bond coat.

8. The method of claim 7, further comprising applying an abradable layer on the EBC layer.

9. The method of claim 1, wherein the precursor comprises a pre-ceramic polymer, wherein the pre-ceramic polymer comprises a polycarbosilane or a polysilazane.

10. The method of claim 9, wherein heat-treating the bond coat and the precursor comprises heat-treating the bond coat and the pre-ceramic polymer at between about 850° C. to about 1300° C. in an inert atmosphere to convert the pre-ceramic polymer to a ceramic.

11. The method of claim 1, wherein the precursor comprises a solution comprising a metallic precursor.

12. The method of claim 11, wherein the solution comprising the metallic precursor comprises a polar solvent and at least one of (NH₄)₂Mo₂O₇, (NH₄)₆Mo₇O₂₄·4H₂O, (NH₄)₂MoO₄, or (NH₄)₁₀(H₂W₁₂O₄₂)·4H₂O.

13. The method of claim 12, wherein heat-treating the bond coat and the precursor comprises heat-treating the bond coat and the precursor at about 450° C. to about 1200° C. in a reducing atmosphere to reduce the NH₄)₂Mo₂O₇, (NH₄)₆Mo₇O₂₄·4H₂O, (NH₄)₂MoO₄, or (NH₄)₁₀(H₂W₁₂O₄₂)·4H₂O to Mo metal or W metal.

14. The method of claim 1, wherein the precursor comprises a metal alkoxide solution, wherein the metal alkoxide solution comprises aluminum alkoxides or zirconium alkoxides.

15. The method of claim 14, further comprising, after infiltrating the metal alkoxide solution into the at least some pores of the plurality of pores, polymerizing the infiltrated metal alkoxide solution to form a sol in the at least some pores of the plurality of pores.

16. The method of claim 15, further comprising, after polymerizing the infiltrated metal alkoxide solution, converting the sol to a plurality of ceramic particles by at least partially precipitating the sol or gelling the sol.

17. The method of claim 1, wherein the precursor comprises a carbonaceous resin.

18. The method of claim 17, wherein the carbonaceous resin comprises furfural, furfuryl alcohol, or a phenolic resin.

19. The method of claim 17, wherein heat-treating the bond coat and the precursor comprises pyrolyzing the infiltrated carbonaceous resin at between about 800° C. and about 1000° C. in an inert atmosphere to form carbon.

20. The method of claim 19, wherein heat-treating the bond coat and the precursor further comprises converting silicon in the bond coat and carbon to form silicon carbide, wherein after heat-treating substantially all the plurality of pores of the bond coat are substantially filled with silicon carbide.
